(19) United States
(12) Patent Application Publication
(10) Pub. No.: US 2007/0142059 A1
(43) Pub. Date: Jun. 21, 2007

(54) User plane location architecture with mobile server for location based services

(75) Inventor: Shengqiang Wang, Raleigh, NC (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/303,580

(22) Filed: Dec. 15, 2005

(51) Int. Cl. H04Q 7/20

(52) U.S. Cl. 455/456.1; 455/457

(57) ABSTRACT

A “user plane” location system for implementing a location based service (“LBS”) such as enterprise fleet tracking includes a number of GPS-enabled wireless mobile units in communication with a wireless network. Location data is periodically transmitted from various “client” mobile units to a “server” mobile unit. The location data relates to the respective physical locations of the client mobile units, and may be determined from GPS signals received by the client mobile units. Once the server mobile unit receives the location data, the location data is processed for use in one or more LBS applications. This may include displaying the location data on a screen or other display of the server mobile unit, including displaying the location data in conjunction with map data. The use of a server mobile unit facilitates portability of the server functionality to remote locations.

### FIELD OF THE INVENTION

The present invention relates to communications and, more particularly, to location or positioning services utilizing wireless devices.

### BACKGROUND OF THE INVENTION

In wireless, radio frequency (RF) communications, certain services or features rely upon determining the location of selected wireless device end users, e.g., geographical coordinates and/or altitude. These services are known as “location based services” (LBS). For example, businesses and governmental agencies may use an LBS for fleet tracking purposes. Other location based services may include location based information and commerce services for providing information to wireless end users relating to their respective vicinities (e.g., business or other service locations), location based billing for wireless or other services, emergency services such as mobile 9-1-1, and group tracking services.

Most location based services are implemented using a “control plane” location architecture. Control plane location architectures take advantage of a wireless network's signaling layer, e.g., the SS7 signaling network, to extract location information from inside the network. In other words, in control plane architectures the network's fixed infrastructure and RF control signals (transmitted between the infrastructure and wireless devices) are used to determine the location of a wireless device. For example, coordinated control signal triangulation between three network base stations and a wireless device might be one method used for determining wireless device location in a control plane architecture.

FIG. 1 shows a typical control plane location architecture or system for an enterprise or business LBS, as implemented on a wireless communication network 10, e.g., a mobile SS7-based network. (SS7 is a control-level protocol/system used on many wireless communication networks, including GSM and ANSI-41 (CDMA) networks, for carrying out the control signaling required for mobility management and call delivery.) The system includes a position determination entity (“PDE”)/serving mobile location center (“SMLC”) 12, a mobile positioning center (“MPC”)/gateway mobile location center (“GMLC”) 14, and an enterprise LBS server 16. The PDE 12 determines the precise position or geographic location of a wireless unit 18, and supports one or more position determining technologies. Multiple PDE's 12 may serve the coverage area of an MPC 14, and multiple PDE's 12 may serve the same coverage area of an MPC 14 utilizing different position determining technologies. The MPC/GMLC 14 serves to retrieve, forward, store, and control position data. It also selects the PDE(s) 12 to use in position determination, and forwards the position to the requesting entity or stores it for subsequent retrieval. In effect, the MPC/GMLC 14 acts as the intermediary and gateway between the enterprise LBS server 16, running in web services space, while the PDE/SMLC 12 runs in signaling space. The PDE/SMLC 12 may utilize and/or work in conjunction with the wireless network's fixed RF infrastructure such as a mobile switching center (“MSC”) or radio network controller (“RNC”) 20 and base stations (“BS”) 22. In operation, the LBS server 16 runs one or more applications/programs for carrying out one or more location based services. In doing so, the LBS server 16 obtains location information about selected wireless units 18 from the network 10 via the MPC/GMLC 14. The information may be transferred over an IP (Internet protocol) or other packet data network 24, e.g., the Internet, using TCP/IP (transmission control protocol/Internet protocol) or the like.

Control plane architectures may be sufficient for certain LBS applications. However, network operator involvement is required for implementing a control plane system, and the enterprise/business typically has to pay a fee for each location lookup. Moreover, it may not be convenient or advantageous for businesses to deploy control plane location based services, since the deployment will typically be at least partly under the control of the network operator. Further, since location information is forwarded to a fixed LBS server connected to the IP network 24, the location information can only be used at that static, fixed location.

### SUMMARY OF THE INVENTION

An embodiment of the present invention relates to a system or method for implementing a location based service (“LBS”) such as enterprise fleet tracking. In operation, location data is obtained at a client mobile unit. (By “mobile unit,” it is meant a mobile phone, wireless PDA, vehicle navigation system, a wireless device with high-speed data transfer capabilities, such as those compliant with “3-G” or “4-G” standards, a “WiFi”-equipped portable computer terminal, or the like.) The location data relates to the location of the mobile unit. The location data is then transmitted over a wireless network to a server mobile unit, where it is processed for use in carrying out the LBS. (By “processed,” it is meant manipulation, storage, transfer, display, or any other operation on or with the data.) For example, the location data may be shown on a display or screen of the server mobile unit, possibly in conjunction with map data, for tracking or other purposes.

In another embodiment, the use of a server mobile unit facilitates portability of the server functionality to remote locations. Thus, for example, a business manager can keep track of fleet vehicles without having to access a fixed server terminal. A group or expedition leader can also use the location system to locate lost individuals (e.g., the individuals are provided with mobile units) in a wilderness or similar setting.

In another embodiment, the mobile units are global positioning system (“GPS”) enabled, and the location data is obtained from GPS receivers in the mobile units. If the server mobile -unit is GPS enabled, its location can be shown on the display/screen in relation to the locations of the other mobile units.

In another embodiment, the location data is sent over a packet data network, e.g., an Internet protocol (IP) network. In such a case, since the server mobile unit is portable, its IP address for receiving packet data transmissions may be dynamic. Accordingly, the system may utilize a dynamic domain name server (typically an existing feature of the network), wherein the mobile units address the location data to a static server hostname associated with the domain name server and server mobile unit, with the domain name server keeping track of the server mobile unit's dynamic IP address.

In another embodiment, the server mobile unit obtains map data for display or other use on the server mobile unit. The map data may be obtained from a map database connected to the network. The particular map data retrieved may be based on the location data, e.g., the server mobile unit may obtain map data corresponding to the geographical area or vicinity of the mobile units' locations as indicated in the location data. The map data may be displayed graphically, including overlaying the location data of the mobile units on the displayed map data in graphical and/or text form. The server mobile unit may also calculate and display distances between the mobile units or the like.

### BRIEF DESCRIPTION OF THE DRAWINGS

The present invention will be better understood from reading the following description of non-limiting embodiments, with reference to the attached drawings, wherein below:

FIG. 1 is a schematic diagram of a “control plane” location architecture according to the prior art;

FIG. 2 is a schematic diagram of a “user plane” location system with mobile server according to an embodiment of the present invention;

FIG. 3 is a schematic diagram of a display portion of the system in FIG. 2; and

FIGS. 4 and 5 are flowcharts illustrating operation of an embodiment of the location system.

### DETAILED DESCRIPTION

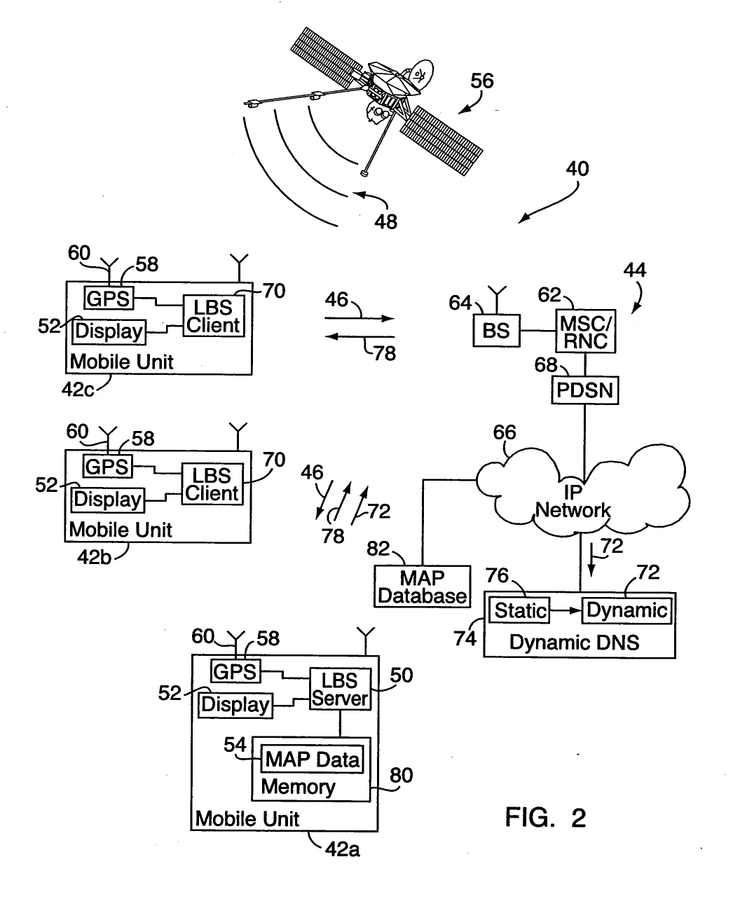

With reference to FIGS. 2-5, an embodiment of the present invention relates to a “user plane” location system 40 for carrying out a location based service (“LBS”) such as fleet or vehicle tracking. The location system 40 may be implemented on or in conjunction with a plurality of global positioning system (“GPS”)-enabled wireless mobile units 42a-42c in communication with a wireless network 44. The mobile units 42a-42c may be mobile phones, wireless PDA's, vehicle navigation systems, wireless devices with high-speed data transfer capabilities, such as those compliant with “3-G” or “4-G” standards, “WiFi”-equipped portable computer terminals, or the like. The wireless network 44 may be, for example, a cellular communication network configured for the wireless transmission of voice and non-voice data.

In operation, location data 46 is periodically sent from certain of the mobile units 42b, 42c (referred to as “client” mobile units) to a “server” mobile unit 42a. The location data relates to the respective physical locations L1, L2 of the client mobile units 42b, 42c. For example, the location data 46 may contain geographical coordinates and an altitude, in addition to information associating the location data 46 with a particular client mobile unit, e.g., an identifier of the mobile unit. The location data 46 may be determined from one or more GPS signals 48 received by the client mobile units 42b, 42c. Once the location data 46 is received by the server mobile unit 42a, the location data is processed for use at the server mobile unit 42a. For example, the location data 46 may be processed by an LBS server module 50 in place on the server unit 42a and configured for carrying out one or more LBS applications. (By “module,” it is meant a software program/script, a hardware unit, and/or a hardware/software unit interfaced with the mobile unit.) This may include displaying the location data 46 on a screen or other display 52 of the server mobile unit 42a, including possibly correlating the location data 46 to map data 54 also shown on the display 52.

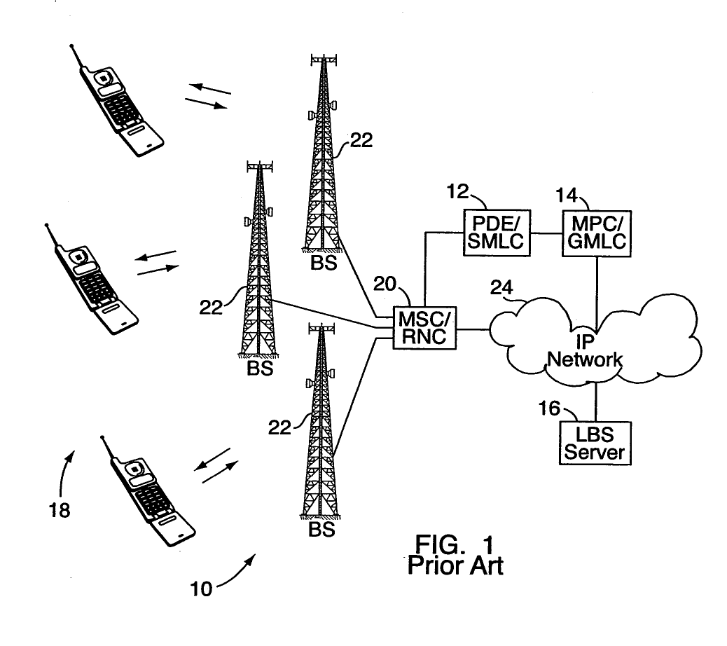

The location system 40 utilizes a user plane location architecture. Here, the location of a client mobile unit 42b, 42c is determined at or by the mobile unit itself, as opposed to the location being determined by the network 44. The location data 46 is then transmitted from the client mobile unit to the server mobile unit 42a. This eliminates the need for the system 10 to interface with a network mobile positioning center (“MPC”) 14 or the like (see FIG. 1), meaning that the system 10 can be implemented without the network operator's involvement or control, and without paying location lookup fees. Also, the use of a server mobile unit 42a eliminates the need to provide a dedicated server terminal connected to the network 44. It also enables the implementation of certain LBS applications not possible on a system with a fixed server terminal.

As noted, the location data 46 may be determined from one or more GPS signals 48 received by the client mobile units 42b, 42c. The global positioning system is a satellite navigation system used for determining an end user's position on the Earth's surface. The GPS includes a constellation of medium earth orbit satellites 56 that transmit several civilian and military encoded time signals 48 down towards the Earth. Each satellite uses an on-board atomic clock to generate the encoded time signals, which are synchronized and maintained through radio communications by several GPS ground control stations. GPS receivers 58 (e.g., portable electronic devices carried by end users) receive and decode the time signals from multiple (four or more) satellites, and the receiver's location (e.g., latitude, longitude, and/or elevation) is calculated from these signals using trilateration algorithms. The GPS receivers 58 may also calculate precise UTC traceable time from the received time signals as modified by any necessary correction factors. Accessing the civilian portion of the GPS service is unrestricted and free of charge.

GPS receivers 58 have gradually reduced in size due to increasingly smaller and more integrated electronics. Accordingly, they are now routinely included even in small mobile units 42a-42c. A GPS enabled mobile unit 42a-42c will typically include a built-in GPS antenna 60 and a miniature GPS receiver 58 operably connected to the mobile unit's operational system, e.g., electronics hardware and/or software.

The network 44 may be any type of wireless communications network. For example, the network 44 may be a CDMA-based 1x-EVDO communications network having a radio network controller (“RNC”) and/or mobile switching center (“MSC”) 62 and one or more fixed base stations (“BS”) 64. (1x-EVDO is an implementation of the CDMA2000® “3-G” mobile telecommunications protocol/specification configured for the high-speed wireless transmission of both voice and non-voice data.) The base stations 64 are provided with various transceivers and antennae for radio communications with the mobile units 42a-42c, while the MSC/RNC 62 directs data transfer to and from the base stations 64 for transmission to the mobile units 42a-42c.

For conducting wireless communications between the base stations 52 and the mobile units 42a-42c, the network 44 may utilize a CDMA (code division multiple access) spread-spectrum multiplexing scheme. In CDMA-based networks, transmissions from wireless devices to base stations are across a single frequency bandwidth known as the reverse link, e.g., a 1.25 MHz bandwidth centered at a first designated frequency. Generally, each mobile unit 42a-42c is allocated the entire bandwidth all the time, with the signals from individual wireless devices being differentiated from one another using an encoding scheme. Transmissions from base stations to wireless devices are across a similar frequency bandwidth (e.g., 1.25 MHz centered at a second designated frequency) known as the forward link. The forward and reverse links may each comprise a number of traffic channels and signaling or control channels, the former primarily for carrying voice data, and the latter primarily for carrying the control, synchronization, and other signals required for implementing CDMA communications. The network 44 may be geographically divided into contiguous cells, each serviced by a base station, and/or into sectors, which are portions of a cell typically serviced by different antennae/receivers supported on a single base station.

The network 44 may include and/or utilize a core packet data network 66 for the long distance wire-line transmission of packet data, and/or for interconnecting various components or portions of the network 44. For example, the core packet data network 66 may be used to connect the MSC/RNC 62 to a network service or administration module, or to one or more external networks such as a public switched telephone network. The core packet data network 66 may be a dedicated network, a general-purpose network (such as the Internet), or a combination of the two. Typically, the MSC/RNC 62 will be connected to the packet data network 66 by way of a packet data serving node (“PDSN”) 68 or the like. For high-speed data transmission across the packet data network 66 (e.g., for facilitating web browsing, real time file transfer, or downloading large data files), the network 44 may use the Internet Protocol (“IP”), where data is broken into a plurality of addressed data packets. Additionally, VoIP (voice over IP) may be used for voice-data transmission. (With VoIP, analog audio signals are captured, digitized, and broken into packets like non-voice data.) Both voice and non-voice data packets are transmitted and routed over the wireless network 44, where they are received and reassembled by the mobile units or other wireless devices to which the data packets are addressed.

As illustrated in FIG. 2, the system 40 includes the LBS server module 50 in place on the server mobile unit 42a. The system 40 also includes an LBS client module 70 running on each client mobile unit 42b, 42c. The client module 70 is interfaced with the GPS receiver 58 in the mobile unit, either directly or indirectly. In particular, the client module 70 may be directly interfaced with the GPS receiver, or it may be indirectly interfaced with the GPS receiver by way of a connection to the mobile unit's operating system (not shown). The client module 70 is configured to periodically send the location data 46 to the server mobile unit 42a. For example, the client module 70 may periodically retrieve location data 46 from the GPS unit 58, and then direct the location data 46 for transmission out over the RF interface by the mobile unit. The location data 46 will typically be reconfigured and/or formatted, either by the client module 70 or otherwise by the mobile unit, for sending to the sever mobile unit 42a. For example, the location data 46 may be included in a formatted message addressed to the server mobile unit 42a. Depending on the available output of the GPS receiver 58, the client module 70 may perform other processing steps or operations on the location data prior to transmission.

If the wireless network 44 is a packet data network as described above, transmissions from the client mobile units 42b, 42c to the server mobile unit 42a will be formatted according to the packet data protocol in place on the network 44, e.g., the Internet protocol, and addressed to the server mobile unit 42a. The server mobile unit 42a may be provided with a hostname and/or IP address in a standard manner as part of the communication scheme in place on the network 44 generally. Because the server 42a is a mobile unit, its IP address may be dynamically assigned by the network 44 on an ongoing basis, such that the IP address may change from time to time. For the client mobile units 42b, 42c to send addressed messages to the server mobile unit 42a, the server mobile unit 42a periodically sends its IP address 72 over the network 44 to a dynamic domain name server (“DNS”) 74. The dynamic DNS 74 may be accessible over the IP network 66, or otherwise connected to the network 44. The dynamic DNS 74 includes a static hostname 76 associated with the server mobile unit 42a and its dynamic IP address 72 as received from the server mobile unit 42a. The client mobile units 42b, 42c are provided with the static hostname, to which the location data 46 is addressed. Transmissions to the static hostname are then routed by the dynamic DNS 74 to the server mobile unit's current dynamic IP address.

The LBS client module 70 may be configured to transmit the location data 46 on a periodic basis, e.g., once every several minutes. Alternatively or in addition, the client module 70 may transmit the location data 46 upon receipt of a polling command 78 received from the server mobile unit 42a. The server mobile unit 42a may poll the client mobile units 42b, 42c by issuing the polling command 78 on an automatic periodic basis, or upon request from a user. For example, the user could input a “refresh” command into the LBS server module 50 for refreshing the location data 46, e.g., stored in the mobile unit's memory 80. The LBS client module 70 may be configured to transmit the location data based on other criteria. For example, the client module 70 could automatically periodically obtain the location data 46 from the GPS receiver 58 (either directly or through the mobile unit's operating system), e.g., once every one or two minutes, but only transmit the location data 46 if the client module 70 determines that the location data has significantly changed. For example, it may not be necessary to transmit the location data if the location of the mobile unit is static, or if the location data only indicates a slight change in location.

Once the location data 46 is received by the server mobile unit 42a from the client mobile units 42b, 42c, the location data 46 is processed for use by the mobile unit 42a and LBS server module 50. Initially, the location data 46 may be stored in the mobile unit's memory 80, including possible reformatting for this purpose. Further processing steps will depend on the type of location based service(s) implemented by the LBS server module 50. One example of a location based service particularly well adapted for the system 10 is a tracking LBS, e.g., for tracking mobile units associated with a fleet of vehicles, individuals, groups of individuals, or objects.

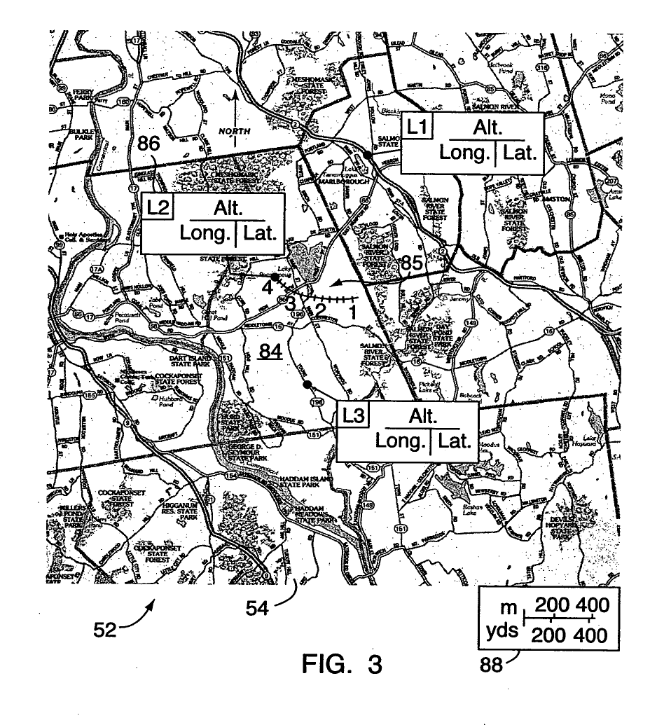

Possible features associated with such an LBS are shown in FIGS. 2 and 3. There, the location data 46 is processed by the LBS server module 50 for displaying on the mobile unit's display/screen 52 for use by an end user. The location data 46 may be simply displayed in text format. Alternatively or in addition, the location data 46 may be correlated to and/or displayed in conjunction with map data 54. The map data 54 may be stored in memory 80, and/or it may be obtained or referenced from a map database 82 accessible over the network 44. For example, upon receipt of the location data 46 from a first client mobile unit 42b, the LBS client module 50 could correlate or cross-reference the location L1 of the client mobile unit to the map database 82, e.g., by sending a query message containing the location data 46 to the map database 82. The map database 82 would then send map data 54 for the geographical vicinity 84 around the location L1, which would be stored in memory 80 and optionally shown on the display 52. Alternatively, the map data 54 could be statically stored in the mobile unit 42a, or it could be downloaded into the mobile unit 42a by way of the user manually accessing the map database 82 and/or a portal Internet website or the like for the database 82, if the user has advance knowledge of the geographical vicinity 84.

FIG. 3 shows an example of the map data 54 and location information as it might be displayed with reference to an LBS application used in the context of tracking individuals during a hike or expedition. For the tracking LBS, each participating individual is provided with a client mobile unit 42b, 42c. The expedition leader or another designated individual carries the server mobile unit 42a, into which has been downloaded map data 54 of the area 84 of the expedition. (Alternatively, the map data 54 could be downloaded “on the fly” based on the locations of the client mobile units, as described above.) In operation, if the leader desires to determine the location of one of the individuals, e.g., an individual carrying client mobile unit 42b, the leader enters a refresh or polling command 78 into the LBS server module 50. The refresh command 78 is then transmitted over the wireless network 44 to the client mobile units 42b, 42c. The client mobile units subsequently send location data 46 back to the server mobile unit 42a. (Alternatively, the client mobile units could periodically automatically send the location data 46 to the server mobile unit 42a.) The map data 54 is then displayed on the server mobile unit's display 52 in graphical and/or text form. For example, as shown in FIG. 3, the map data 54 may be a topographic map including elevation data and geographical and political features. The portion of the map data 54 displayed may be based on the location data received from the client mobile units. For example, it may be desirable to center the map image around the locations L1, L2 of the client mobile units, and/or to scale the map image for showing the locations of all the client mobile units on the display 52. The LBS server module 50 may be configured to allow the end user to scale and/or move the displayed map image, e.g., “zoom in,” “zoom out,” and pan functions. The LBS server module 50 could also selectively show past locations for determining the paths of travel of the mobile units, either on a “point-by-point” basis or by way of extrapolated line segments. See graphical pathway 85 in FIG. 3.

As indicated in FIG. 3, the locations L1, L2 of the client mobile units may be graphically superimposed on the map data 54 shown on the display 52, by correlating the location data 46 to the map coordinates. For example, if the location data 46 includes geographical coordinates and an altitude, this information may be cross-referenced to the map's coordinate and/or altitude data for displaying the locations L1, L2. Along with showing the actual location points, other data may also be displayed. For example, a graphic “text box” 86 may be displayed in association with each client mobile unit 42b, 42c. The text box could include an identifier of the mobile unit, the coordinates and altitude of the mobile unit, or the like. The LBS server module 50 could be configured to place or route the text boxes so that they do not overlap or obscure the locations of other client mobile units, or the end user could control placement of the text boxes, including selecting whether text boxes are displayed for particular mobile units, the particular information shown in the text boxes, or the like. The displayed map data 54 could also include a scale and other map legend data 88.

Like the client mobile units 42b, 42c, the server mobile unit 42a may be GPS enabled for determining a location of the server mobile unit, in a manner similar to as described above. The location information L3 for the server mobile unit 42a could be similarly displayed on the display 52 of the server mobile unit 42a, in relation to the other mobile units or otherwise. In addition, the LBS server module 50 could be configured to calculate and display the distance between the server mobile unit 42a and selected client mobile units 42b, 42c, and/or compass data of the client mobile units in relation to the server mobile unit, either graphically or via text. Such features could be selectable by the end user.

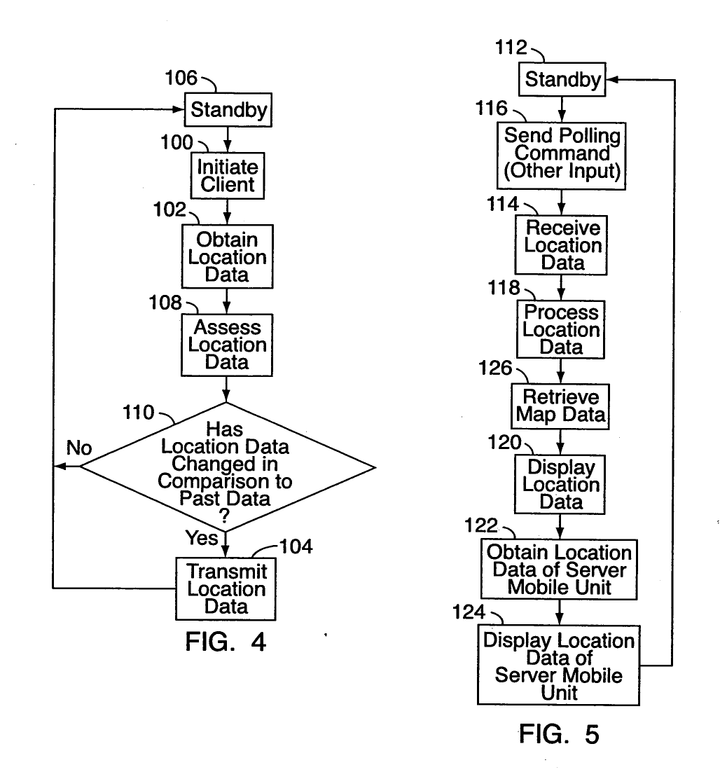

FIGS. 4 and 5 summarize operation of an embodiment of the location system 40. At Step 100 in FIG. 4, the LBS client module 70 in a client mobile unit 42b, 42c is initiated for obtaining and transmitting location data 46. For example, the LBS client module 70 may be configured to automatically periodically obtain and transmit the location data, or it may be configured to obtain and transmit the location data upon receipt of a polling command 78. In between, the client module 70 may be in a “standby” or “sleep” mode 106 or the like. At Step 102, upon initiation, the LBS client module 70 obtains location data 46 from the mobile unit, e.g., from the GPS receiver 58. At Step 104, the location data 46 is transmitted to the server mobile unit 42a. As discussed above, this may include formatting the location data 46. The location data 46 will typically be inserted into a message addressed to the server mobile unit hostname, and transmitted by the mobile unit in a standard manner according to the communications protocols in place on the network 44. After transmission, the client module 70 may return to a standby mode 106.

FIG. 4 further indicates that the LBS client module 70 may optionally assess the location data 46 prior to transmission, as at Step 108. For example, as noted above, the client module 70 at Step 110 could compare the location data 46 to prior location data, as stored in memory, for transmitting the location data only if the location of the mobile unit has significantly changed.

At Step 112 in FIG. 5, the LBS server module 50 optionally lies in a standby mode. The server module 50 may exit the standby mode upon receipt of location data at Step 114, or upon the entry of one or more commands by the user at Step 116, including possibly sending a polling command 78. (Sending a polling command or the like is optional.) The server module 50 may be configured in other manners, without a standby mode or the like. At Step 114, location data 46 is received from one or more client mobile units 42b, 42c. At Step 118, the location data is processed for further use, as described above. For example, the location data may be displayed on the server mobile unit's display 52, as at Step 120. The LBS server module 50 may be further configured to obtain location data relating to the location of the server mobile unit 42a, e.g., from the GPS receiver of the server mobile unit (Step 122), and to display its location on the display 52 (Step 124), alone or in conjunction with location data from the client mobile units. At Step 126, the LBS server module 50 may also retrieve map data 54, based on the location data 46 or otherwise, for correlating to the location data 46 and/or for displaying on the display 52 in reference to the location data.

Although the location system has been primarily illustrated as having an LBS server module in place on one mobile unit and LBS client modules in place on other mobile units, it should be appreciated that more than one mobile unit could be provided with the LBS server module, and that the LBS server modules could be configured to send location data (relating to the location of their respective mobile units) to other server module-equipped mobile units.

Although the location system of the present invention has been primarily illustrated with respect to the global positioning system, it should be appreciated that the system could also be implemented with similar global or regional positioning systems. As such, the terms “GPS” and “global positioning system” as used herein refer to not only the global positioning system as maintained by the U.S. government, but also to similar systems (e.g., the European/Chinese Galileo system), whether public or private.

An additional embodiment of the present invention may be characterized as a system 40 for tracking a number of objects (e.g., people, vehicles) over a wireless network 44. Each object is provided with a client mobile unit 42b, 42c. Each client mobile units 42b, 42c is configured to periodically automatically obtain location data relating to a current location of the remote mobile unit and to transmit the location data over the network to a designated server identifier, e.g., the static hostname 76. The system further includes a server mobile unit 42a configured to receive the location data sent to the designated server identifier 76. The server mobile unit 42a also periodically obtains location data relating to its location. A tracking application 50 runs on the server mobile unit. The tracking application 50 is configured to process the location data of the remote mobile units relative to the location data of the server mobile unit for use in tracking the remote mobile units.

Since certain changes may be made in the above-described user plane location architecture with mobile server for location based services, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for communicating with at least one mobile unit over a wireless network, the method comprising the steps of:
periodically receiving at a server mobile unit location data from at least one client mobile unit, said location data relating to a location of the client mobile unit; and
processing the location data for use by a location based service application running on the server mobile unit.

2. The method of claim 1 further comprising:
periodically obtaining location data relating to a location of the server mobile unit, wherein the location data of the at least one client mobile unit is processed at least in part relative to the location data of the server mobile unit.

3. The method of claim 2 further comprising:
displaying on a display of the server mobile unit the location data of the server mobile unit and the location data of the client mobile unit.

4. The method of claim 3 further comprising:
graphically displaying on the display map data relative to the location data of the server mobile unit and client mobile unit.

5. The method of claim 2 further comprising:
calculating at least one of a distance, an altitude, geographical coordinates, and a compass bearing between the location of the server mobile unit and the location of the client mobile unit.

6. The method of claim 5 further comprising:
displaying on a display of the server mobile unit the location data of the server mobile unit and the client mobile unit, and displaying on the display said at least one of the distance, the altitude, the geographical coordinates, and the compass bearing between the location of the server mobile unit and the location of the client mobile unit.

7. The method of claim 1 further comprising:
displaying the location data on a display of the server mobile unit.

8. The method of claim 7 further comprising:
displaying map data relating to the location data on the display.

9. The method of claim 8 further comprising:
obtaining location data relating to a location of the server mobile unit; and
displaying the location data of the server mobile unit on the display relative to the location data of the client mobile unit.

10. The method of claim 9 wherein:
the map data is displayed graphically; and
the method further comprises additionally displaying text information relating to the location data on the display.

11. The method of claim 10 wherein the text information comprises at least one of an altitude of at least one of the server mobile unit and the client mobile unit, geographical coordinates of at least one of the server mobile unit and the client mobile unit, a distance between the server mobile unit and the client mobile unit, and a compass bearing of the server mobile unit relative to the client mobile unit.

12. The method of claim 1 further comprising:
comparing currently received location data from the client mobile unit to previously received location data from the client mobile unit; and
displaying on a display of the server mobile unit the currently received location data relative to the previously received location data.

13. The method of claim 1 further comprising:
periodically transmitting a polling command to the at least one client mobile unit for initiating transmission of the location data.

14. A method for communicating over a network with a plurality of client mobile units, the method comprising the steps of:
periodically receiving at a server mobile unit location data from each of said plurality of client mobile units, said location data relating to respective locations of the plurality of client mobile units; and
processing the location data for use by a location based service application running on the server mobile unit, for tracking the plurality of client mobile units.

15. The method of claim 14 further comprising:
periodically obtaining location data relating to a location of the sever mobile unit, wherein the location data of the plurality of client mobile units is processed at least in part relative to the location data of the server mobile unit.

16. The method of claim 14 further comprising:
displaying on a display of the server mobile unit the location data of the client mobile units and the server mobile unit relative to graphically displayed map data.

17. The method of claim 16 further comprising:
displaying on a display of the server mobile unit, for at least one of said plurality of client mobile units, at least one of an altitude, geographical coordinates, a distance to the server mobile unit, and a compass bearing relative to the server mobile unit.

18. A system for tracking a plurality of objects over a wireless network, said system comprising:
a plurality of client mobile units each associated with one of said objects, wherein each of said client mobile units is configured to periodically automatically obtain location data relating to a current location of the client mobile unit and to transmit the location data over the network to a designated server identifier;
a server mobile unit configured to receive the location data sent to the designated server identifier and to periodically obtain location data relating to a location of the server mobile unit; and
a tracking application running on the server mobile unit, wherein the tracking application is configured to process the location data of the client mobile units relative to the location data of the server mobile unit for use in tracking the client mobile units.

19. The system of claim 18 wherein the server mobile unit has a display, said tracking application being configured to show on the display the location data of the server mobile unit relative to location data of the client mobile units.

20. The system of claim 19 wherein the tracking application is further configured to obtain and graphically display map data on the display, said map data relating to the location data of the client mobile units and the server mobile unit, and to show on the display, for at least one of said client mobile units, at least one of an altitude, geographical coordinates, a distance to the server mobile unit, and a compass bearing relative to the server mobile unit.
